(19) United States
(12) Patent Application Publication
(10) Pub. No.: US 2015/0222584 A1
(43) Pub. Date: Aug. 6, 2015

(54) METHODS AND APPARATUS FOR MESSAGE PRIORITIZATION AND GPS MAPPING DURING INSTANT MESSAGING SESSIONS.

(71) Applicant: James Henry Holliday, Roseville, CA (US)

(72) Inventor: James Henry Holliday, Roseville, CA (US)

(21) Appl. No.: 14/565,060

(22) Filed: Dec. 9, 2014

Related U.S. Application Data
(60) Provisional application No. 61/913,589, filed on Dec. 9, 2013.

(51) Int. Cl. H04L 12/58; G06F 3/0482; G06F 3/0484

(52) U.S. Cl. CPC H04L 51/20; H04L 51/22; H04L 51/046; G06F 3/04842; G06F 3/0482

(57) ABSTRACT

An enhancement to allow additional instant messaging functionality based on a set of instant message capable devices. Devices are set up to identify their contacts and the functionality they will receive. Additional functionality includes embedding GPS coordinates into messages and priority response by pushing messages into the active session and disabling the instant message application's navigation controls. When received text messages contain embedded GPS coordinates, globe icons are displayed next to the message. Pressing the icons displays an interactive map showing the location of the sending device at the time the instant message was sent. Outgoing text messages are monitored for key emergency number phrases and if found the enhancement sends an interactive map showing the current location of the device to all emergency contacts.

CROSS-REFERENCE TO RELATED APPLICATION AND CLAIM OF PRIORITY

This patent application claims priority under 35 U.S.C.§1.119(e) from a Provisional Patent Application No. 61/913,589, filed Dec. 9, 2013.

### BACKGROUND OF THE INVENTION

1. Field of the Invention

The present invention relates generally to mobile communication devices, and more particularly, to instant messages and GPS location.

2. Description of the Related Art

In general, text messaging behavior is consistent for all sending and receiving parties across all message sessions. A user has the ability to jump between sessions without regard to the other participants. The user picks the session they wish to participate in and may completely ignore other sessions.

### BRIEF DESCRIPTION OF THE DRAWINGS

The invention may be understood by reference to the following description taken in conjunction with the accompanying drawings. Numbers in “( )” parentheses identify elements within the drawing, and in which:

FIG. 1 illustrates a view of a screen representative of a graphical user interface of a prior art instant messaging system;

FIG. 2 illustrates the interaction between the mobile device, GPS satellite and access provider to obtain the current GPS co-ordinates of a mobile device;

FIG. 3 illustrates a screen representative of a device's graphical user interface to maintain priority options for contacts. Both an Apple and a Samsung cell device are illustrated;

FIG. 4 illustrates a screen representative of a device's graphical user interface to edit an individual priority contact's information and options;

FIG. 5 illustrates a screen representative of a computer application graphical user interface to enable priority functionality for a contact;

FIG. 6 illustrates a view of an instant message session between two devices. The simulation depicts a session, that does not include the functionality from this invention, between a parent and child;

FIG. 7 illustrates the result of the same instant message session depicted in FIG. 6 enhanced with this inventions I.M. Priority and embedded GPS Map coordinates functionality;

FIG. 8, the left side image illustrates the screen representative of the parent instant message session from FIG. 7 with the addition of a GPS Mapping Option popup window. The right image illustrates the parent device screen representative of a graphical user interface displaying an interactive map accessed via the left image popup;

FIG. 9, upper portion, illustrates the process flow followed when a device that contains this new invention receives an instant message. The lower portion of the drawing depicts the process flow when the user presses the Send button;

FIG. 10 illustrates the process flow followed when a device that contains this new invention sends an instant message to a recipient they selected;

FIG. 11 illustrates the process flow followed when a priority contact receives an Instant Message;

FIG. 12 illustrates the process flow followed when a device that contains this new invention sends an instant message that begins with the user defined emergency number (IE. 911 in the US).

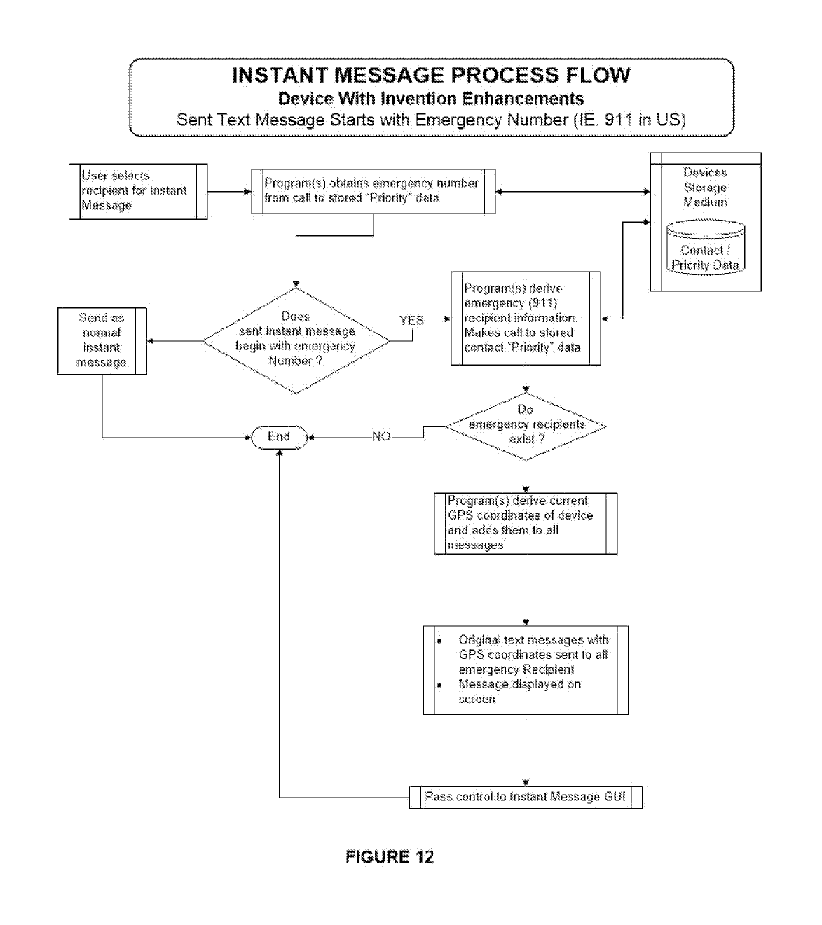

### DETAILED DESCRIPTION OF THE PREFERRED EMBODIMENT

A preferred embodiment of the present invention will be described herein below with reference to the accompanying drawings. In the following description, well-known functions or constructions are omitted to avoid obscuring the invention with unnecessary detail.

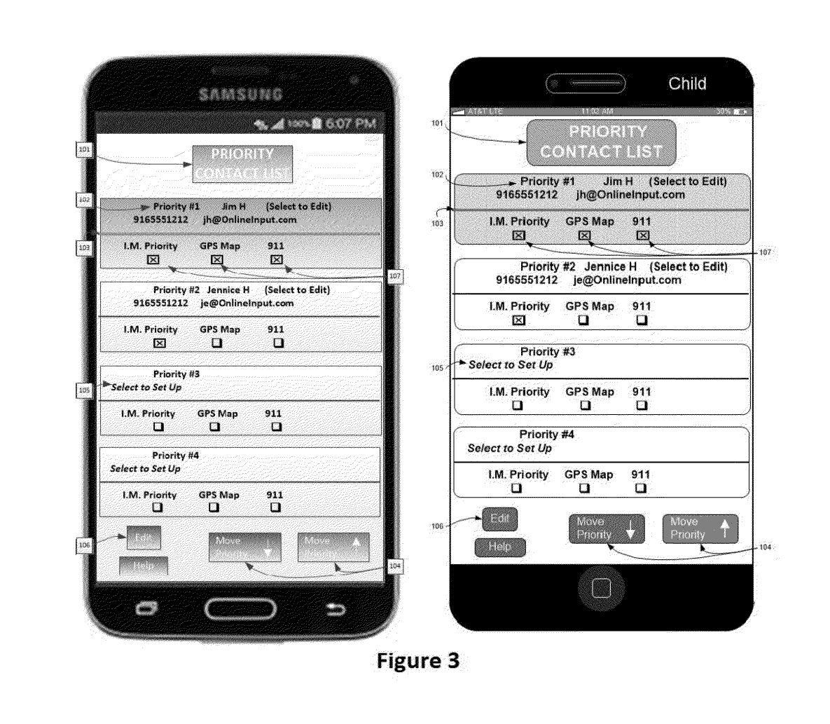

Details, with illustrations, are described below. Not all features of the implementation are covered in this description. The implementation will follow the “look and feel” of an existing device's instant message system that is enhanced with this additional functionality and may therefore vary depending on that system. Although many of the illustrations depict cell phones, the invention may be implemented on any communication device. The invention relies on additional priority option attributes that are associated to the device's contacts. The purpose of FIGS. 3, 4 and 5 is not to define the implementation but to show the additional priority option attributes that need to be present to enable the invention. The implementation for each device and application may be different.

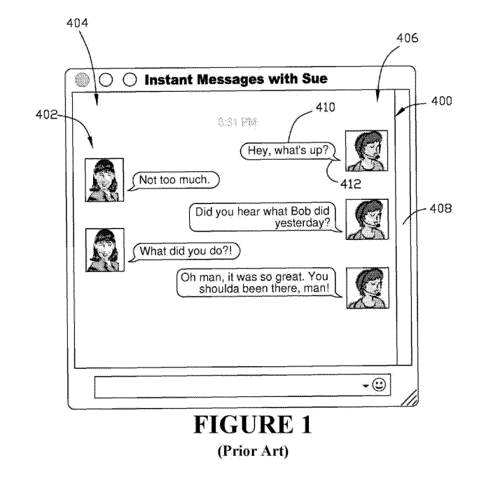

NOTE: Although description of the drawings may mention the colors blue, green, and red, the drawings are black and white and the mentioned colors are used to help the reader visualize a possible implementation. The color schemes used for each implementation should match those used by the original instant messaging application. An example of a fictitious instant message session between two parties is illustrated in the FIG. 1 prior art. Although future illustrations may utilize the look and feel of this example, it is not intended that this invention is dependent upon this look and feel.

Looking at FIG. 3, illustrates a type of device (cell phone) depicting a possible implementation of a Priority Contact List maintenance GUI. The purpose of this screen is to graphically display the priority options. The actual implementation to add these options will depend on the core instant messaging system that the enhancement is added to. Access to the Priority Contact List may be password protected. The logic and password screens are not depicted, as they will be different based on the device.

The priority option settings allow the user to identify “Priority Contacts” that will acquire additional methods based on checked priority options (107). The priority # (102) reconciles who receives higher priority when two contacts have simultaneous open active instant message sessions as described later in this section.

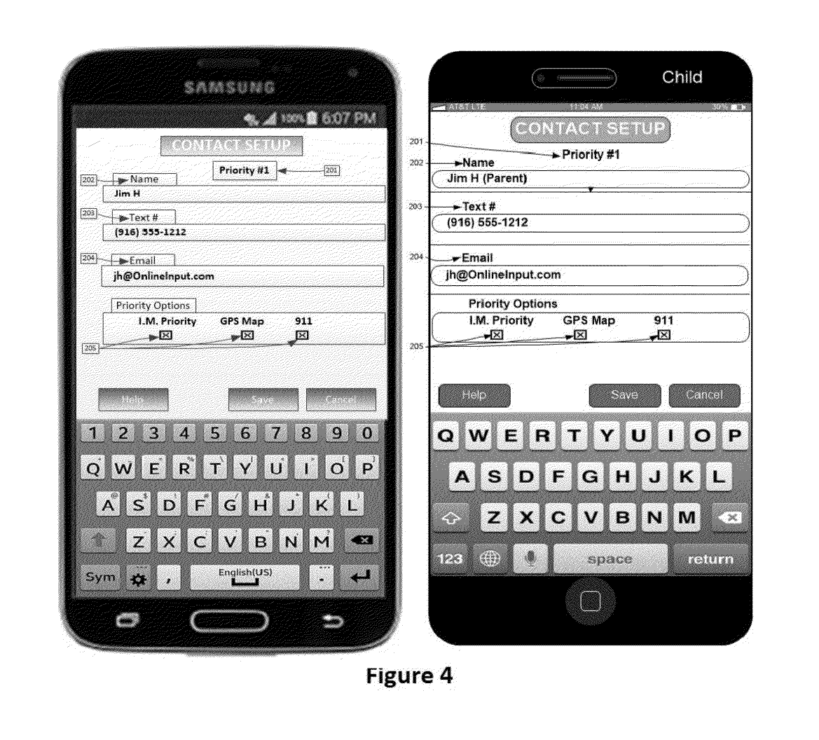

The Priority Contact List GUI allows the user to Touch/Select (103) a priority and then perform actions on that priority. A selected priority may be moved up or down by using the appropriate buttons (104), resulting in its priority # changing. Priorities in the Select to Set Up (105) status cannot be moved above a completed priority. A Press/Hold on the select priority or selecting the Edit (106) button will result in the application rendering the Contact Setup GUI, illustrated on the device in FIG. 4, populated with the selected contact's priority information from FIG. 3.

Looking at FIG. 4, The Contact Setup GUI allows the user to setup a contact with priority options. The input screen will mimic the “look and feel” of the device implementing this invention. The three checkboxes (205) enable/disable additional functionality (detailed below). The Text # (203) is used to match to incoming and outgoing instant messages to determine that this is a priority contact. The email address (204) is used to send email to the contact when instant messaging to the contact fails.

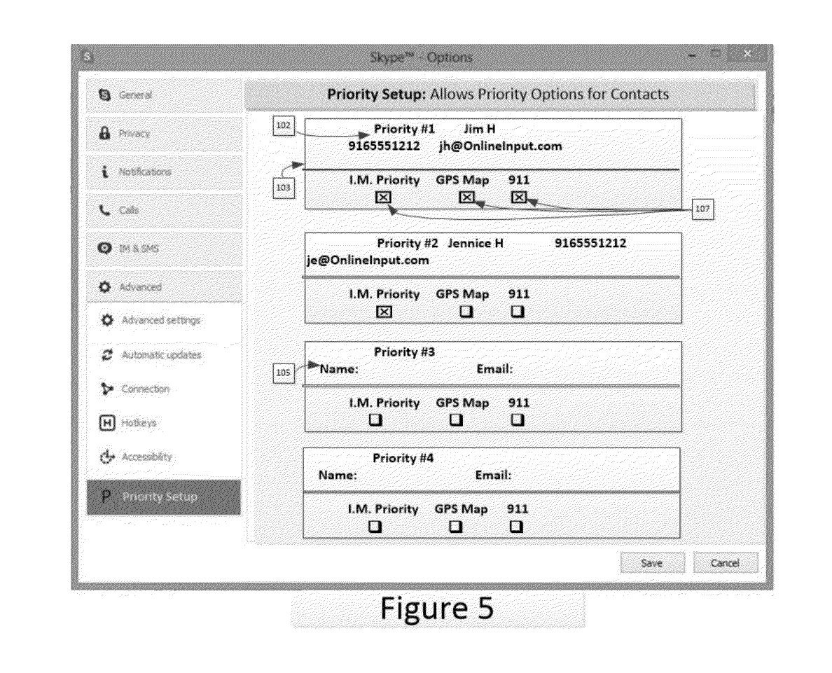

Looking at FIG. 5, illustrates a possible look and feel for a Priority Setup for contacts on an alternate instant message platform.

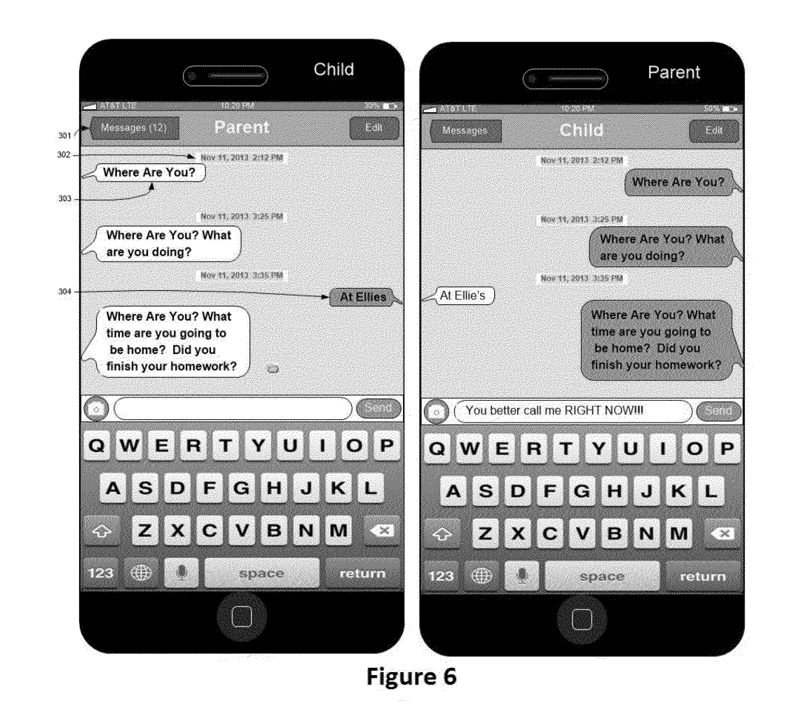

Looking at FIG. 6, an instant message communication scenario between the Parent and Child devices is illustrated. The “look and feel” of this scenario mimic's a current instant message application that is not enhanced with this invention. Outgoing messages (304) are on the right portion of the screen, incoming (303) on the left portion. A timestamp (302) is displayed above the message(s). A single timestamp can encompass multiple messages if they are processed immediately after the prior message. This scenario does not include the new features that will be provided by this invention. Looking at “Messages” button (301) on the Child device, shows twelve other unanswered instant message in the queue. There is no “priority” for the sessions on the Child device and the user has the ability to switch to any of the sessions at any time, thus setting their own priority to respond to the messages.

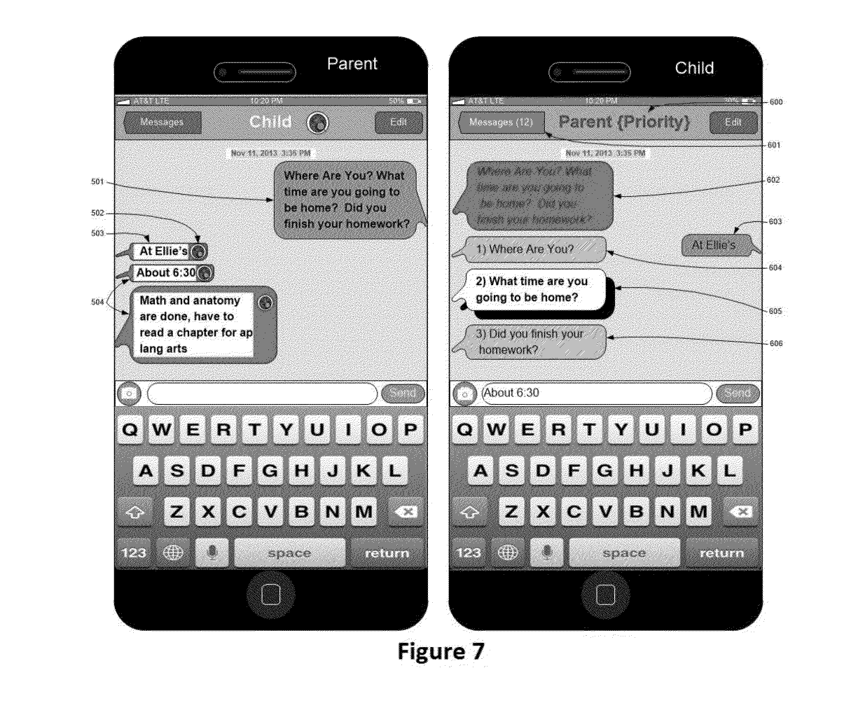

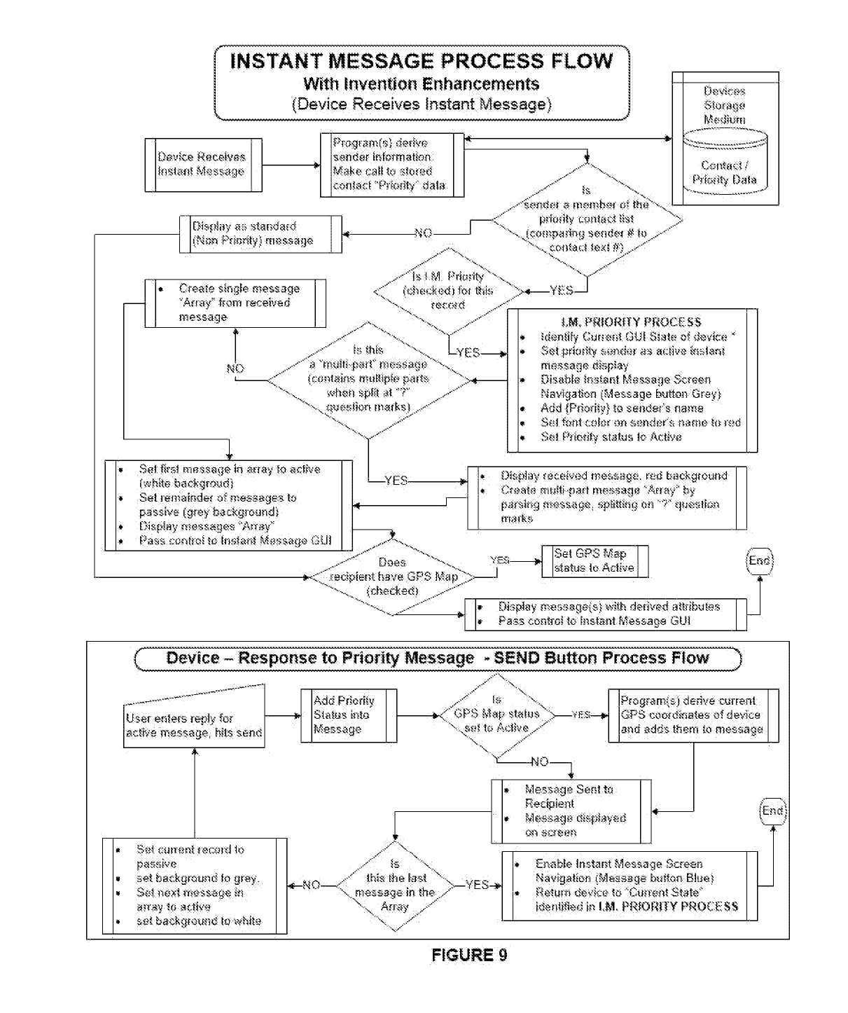

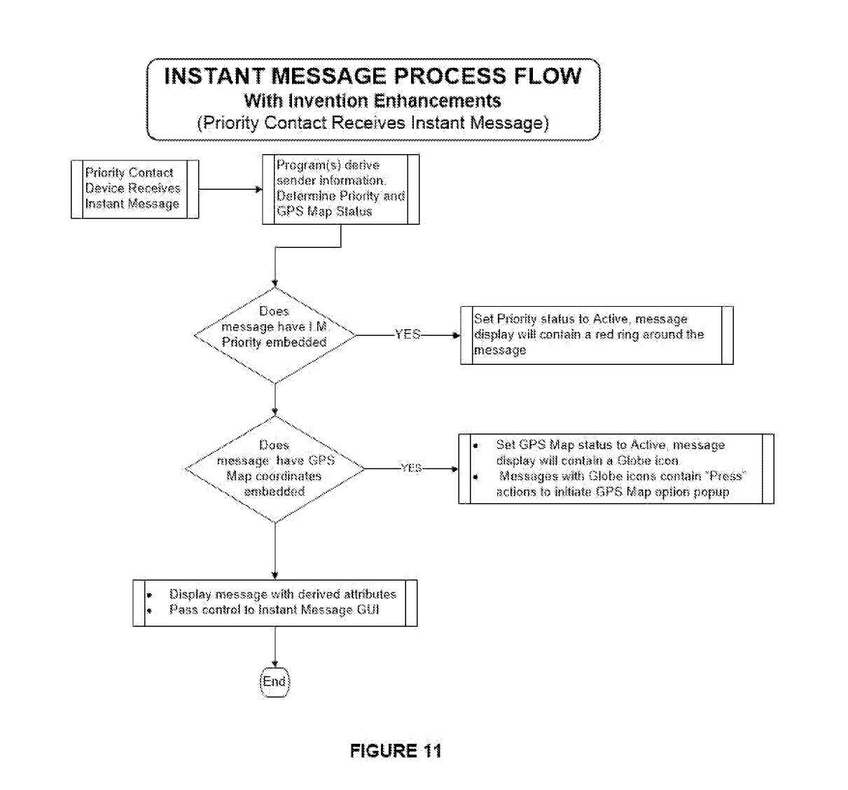

Looking at FIGS. 7 illustrates an instant message session enhanced with this new invention. The Parent device, as shown in the upper right corner, displays the first communication (501) of an instant message session. It is three questions sent as a single message. The right image illustrates the receipt of this instant message (602) on the Child device. Since the sender, Parent, is set up in the Child's device as an “I.M. Priority” parent (See FIG. 3), multiple processing actions occur on the Child device with the receipt of this message. The sender, Parent, is pushed into the active instant message window and set as “Priority”, with {Priority} added to the sender's name (600). The ability to switch to another session is disabled. The message button (601) is disabled and the button is shown in disable status (Grey). The recipient device then checks if the received message is a “multi-part” which is determined by a message that can be split into more than one message by a “?” question mark. Since this message is a multi-part, the original message (602) is displayed in red, and the parts are split out into individual message by splitting the original on each “?” question mark. The parts are displayed in either an “Active” or “Passive” state. The Active state (605), in white, is the question that is now awaiting an answer. Passive state questions (604&606) are shown in the disabled state of grey. The recipient, Child, will be forced to answer each individual message before obtaining the ability to switch to a different session. The right illustration shows that the Child has already answered the first part of the message (604), now shown in grey, with the outgoing response (603) shown in green to its right. The process flow for the receipt of an instant message is detailed in FIGS. 9 and 11.

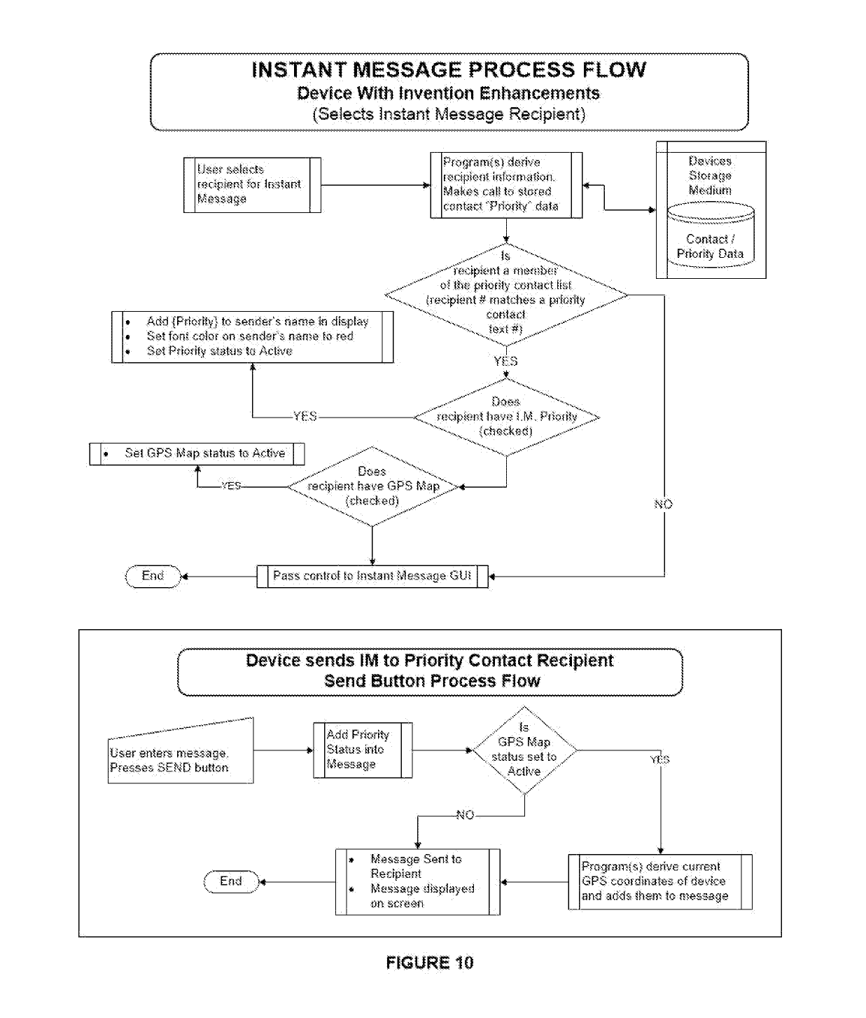

When an instant message is sent, the application first determines if the intended recipient is a member of the Priority Contact List (See FIG. 3). This is accomplished by comparing the intended recipient's text number to Text #'s in the Priority Contact List (See FIGS. 3 & 4). If the recipient is a member, additional information will be added to the sent message depending on the checkbox setting for I.M. Priority and GPS Map. I.M. Priority will add a Priority indictor in the message. GPS Map will cause the application to obtain the current GPS coordinates of the device and then embed that information in the message. The process flow for the sending of an instant message is detailed in FIG. 10.

Looking back at the left image in FIG. 7, you see the results of the instant message session after Child has replied to all three parts of the multi-part instant message (503&504). Each answer is shown as a separate response. The red color ring around each response denotes that the recipient is an I.M. Priority contact member on the sender's device. The globe icon (502) embedded in the red ring denotes that the recipient, Parent, is a GPS Map member as part of his priority membership (See FIGS. 3 and 4).

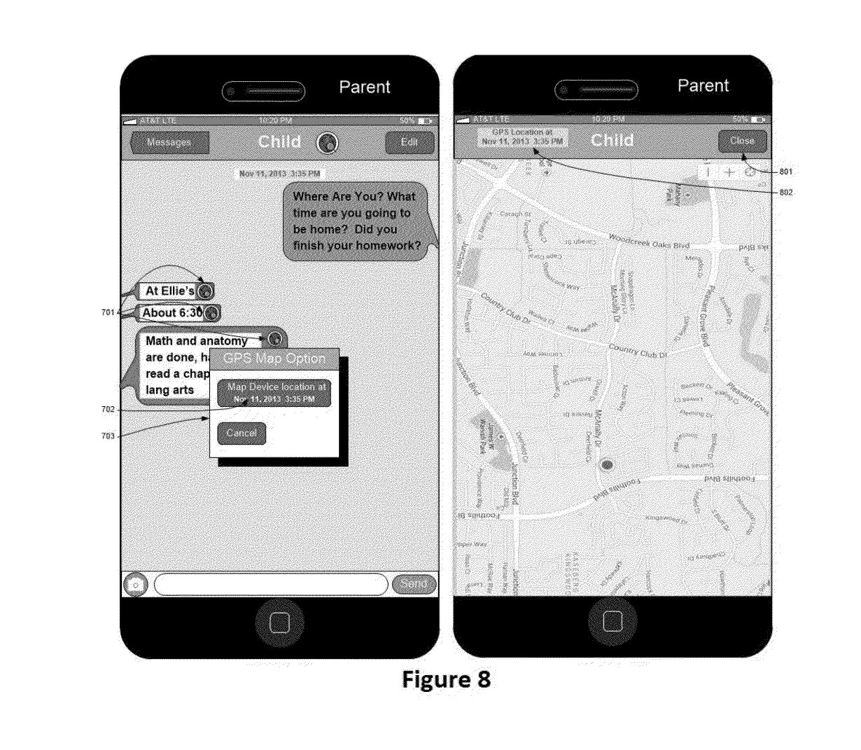

Looking at FIG. 8, each receive message (701) displays a globe icon since the messages contain GPS coordinates,. When the user presses on one of the instant message icons, (701) the GUI pops up a GPS Map Option window (703). Pressing the “Map Device location” button (702) displays an interactive map showing the physical location of the device at the time the message was sent. The date and time (802) is displayed above the map. Pressing the close button (801) closes the map and returns the GUI back to the instant message display.

Since the GPS information is embedded within the message, the recipient has the ability to check the device's physical location history at any point in time that an instant message was received throughout the message thread. If the Parent phone contains the invention, the reply messages will show with a Globe icon in the message. Otherwise the coordinates will be tagged text embedded in the message. IE. <GPS 38.752209,-121.287885> At Ellie's and the receiver can use a site such as http://boulter.com/gps/ http://maps.google.com to map the location.

The 911 checkbox is utilized during outgoing messages. If an outgoing text message starts with 911, then the app will send the message and a map to all members of the parent list with the 911 priority option checked. Since non-US countries use emergency numbers other than 911, the checkbox name and text comparison value should be definable depending on the emergency number the user defines.

While the invention has been shown and described with reference to a certain preferred embodiment thereof, it will be understood by those skilled in the art that various changes in form, and details may be made therein without departing from the spirit and scope of the invention as defined by the appended claims.

### REFERENCES CITED

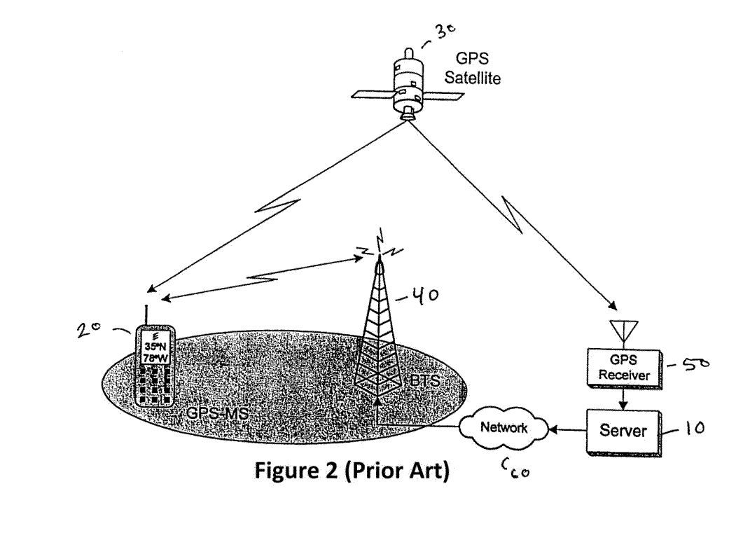

US Patent Documents

| | | | | Figure |
|---|---|---|---|---|
| | | | | Used |
| | Issue | | | from |
| Document # | Date | Inventor | Assignee | Publication |
| 8,458,278 | Jun. 4, | Christie; Gregory N | Apple Inc. | FIG. 1 |
| | 2013 | | | |
| 6,801,778 | Oct. 5, | Havish Koorapaty, L | Ericsson | FIG. 2 |
| | 2004 | Scott Bloebaum | Inc. | |
| D590804 | Apr. 21, | Steven Tkachuk | Samsung | |
| | 2009 | | Electronics | |
| | | | Co., Ltd. | |
| US8385897B1 | Feb. 26, | Rani Yadav-Ranjan | Navigator | |
| | 2013 | | Technology, | |
| | | | Inc. | |

1. Global messaging system enhancements comprising:
a) A method to create and store information detailing a relationship and acquired functionality between a plurality of communication devices.
b) A method for a communication device, upon receiving an instant message, to determine if the sender has a defined relationship and the functionality derived from that relationship.
c) A method that modifies the behavior of a message session based on the set of option choices determined by the relationship between the sender and recipient of the message.
d) A method that obtains GPS coordinates and embeds them within a message.
e) A method that extracts GPS coordinates from a message and then displays an interactive map utilizing those coordinates.
f) A method that monitors outgoing instant message and based on the message text performs actions.

2. The method of claim 1, wherein the information is stored in a retrievable digital format on the Child device.

3. The method of claim 1, wherein a computer-readable memory storing instructions which, when executed by one or more processors, cause the one or more processors to perform a graphical user interface (GUI) screen allowing a user to view details of relationships to other devices.

4. The computer-readable memory of claim 3, wherein the program instructions, when executed on the child device by the one or more processors, further cause the one or more processors to display in a GUI application the list of all priority contacts and their priority options with buttons for edit, help and move priority up or down.

5. The method of claim 4, wherein: once the user selects a specific contact record, the following actions may be performed:
a) In response to detecting that the user has pressed one of the enabled Move Priority buttons, program instruction will adjust the order of the priorities by moving the selected priority in that direction. The enable/disable status of the priority buttons is determined by program instructions that utilize the current location of the priority and its relation to other set up priority entities. The resulting order will be stored in computer readable storage medium within the child device.
b) In response to detecting that the user has pressed the help button, program instruction will display a popup help GUI detailing the attributes and functionality of the screen.
c) In response to detecting that the user has activated the edit button, program instruction will display an edit GUI to allow the user to modify the currently selected contact.

6. The method of claim 1, wherein a computer-readable memory storing instructions which, when executed by one or more processors, cause the one or more processors to perform a graphical user interface (GUI) screen allowing a user to edit the details of a priority relationship between the current device and a set of contacts.

7. The method of claim 6, wherein: the user has the ability to enter text data into the Name, Text #, and email address fields of the GUI. In addition, the user has the ability to select checkbox values, thus turning on or off, the I.M. Priority, GPS mapping and 911 (emergency number) options of the application for the selected contact. The data will be stored in computer readable storage medium within the device.

8. The method of claim 1, wherein: when setup within a device an instant message received from a “Priority Contact” will obtain priority status thru one or more sets of programming instructions.

9. The method of claim 1, wherein: thru one or more sets of programming instructions, when a device is sending an instant message to a GPS Map enabled contact, it will “retrieve” its current GPS coordinates. The coordinates, will be embedded into all instant messages sent to the contact.

10. The method of claim 1, wherein a set of one or more programming instruction will, cause; when a device receives an instant message determined to be of priority status, that message will be placed into the active display on the GUI. All navigation to move away from this message will be disabled. Messages with multiple “?” (question marks) will be split into multiple message parts that require separate replies. Once the user replies to all message parts, navigation capabilities will return back to normal.

11. The display of claim 6, wherein: a set of one or more programming instruction will cause the received instant message text to display with a red border denoting the priority status.

12. The device of claim 5, wherein: a set of one or more programming instruction will cause a Globe Icon to appear on any received text message that contains GPS Map information.

13. The method of claim 1, wherein a set of one or more programming instruction will display an interactive GPS map using the GPS coordinates described in claim 5 when the user presses the Globe Icon described in claim 9.

14. The method of claim 1, wherein a set of one or more programming instruction will, cause; when a device sends an instant message the text of the message will be compared to emergency number string(s) stored in computer readable storage medium within the device.

15. The result of claim 14, wherein: if a match, programming instructions will forward the text message with embedded GPS coordinates to all emergency (911) priority contacts retrieved from the storage medium within the device.
